(19) United States
(12) Patent Application Publication
(10) Pub. No.: US 2014/0255868 A1
(43) Pub. Date: Sep. 11, 2014

(54) HOLDING DEVICE FOR AN INTRAORAL SCANNER

(71) Applicant: a.tron3d GmbH, Klagenfurt am Worthersee (AT)

(72) Inventors: Jurgen JESENKO, Finkenstein (AT); Franz ISOLA, Radenthein (AT); Horst KOINIG, Klagenfurt (AT)

(73) Assignee: a.tron3d GmbH, Klagenfurt am Worthersee (AT)

(21) Appl. No.: 14/200,844

(22) Filed: Mar. 7, 2014

(30) Foreign Application Priority Data
Mar. 8, 2013 (AT) GM 77/2013

(51) Int. Cl. A61C 9/00

(52) U.S. Cl. CPC A61C 9/0093
USPC 433/28; 433/141; 433/32; 433/27

(57) ABSTRACT

A holding device with a base element for a handpiece of an intraoral scanner, which has a head area (3), has a receiving area (5) of the base element (1), in which the head area (3) can be snugly accommodated at least partially. The receiving area (5) has an interior (8) with at least two holding areas (10, 11), which are arranged essentially opposite to one another.

### FIELD OF THE INVENTION

The invention relates to a holding device with a base element for a handpiece of an intraoral scanner, which has a head area.

### BACKGROUND OF THE INVENTION

Intraoral scanners are increasingly used in dental medicine, since they have many advantages relative to the conventional assessment of the dental structure of patients. Impressions, which are unpleasant for the patients, are eliminated, and radiation-based imaging methods such as X-rays can sometimes be avoided. The space requirement that is frequently substantial is disadvantageous, however, since many systems are available as integral devices in which a computer, monitor, and handpiece form a unit. In these embodiments, the scanner is run on a rolling cart to the treatment chair. Other systems can be operated with conventional computers. In such cases, the visual output of the scan is done via the normal computer display. The handpiece that is necessary in any case can then be connected, for example, via a USB port to the computer. Many times, separate interfaces are located on the treatment chair for this purpose. Especially advanced systems have the option of a wireless data transfer and can thus be used especially comfortably. A problem develops in all systems if the scanner is not used. A larger cart is generally impractical, and the usual storage options attached to a treatment chair are in general unsuitable for intraoral scanners, since the latter are in general distinguished in their shape from the otherwise common treatment devices.

### SUMMARY OF THE INVENTION

It is therefore the object of the invention to make available a holding device for an intraoral scanner that is especially comfortable for the user and that can optionally be retrofitted.

This object is achieved by a holding device of the above-mentioned type, which is characterized by a receiving area of the base element, in which the head area can be snugly accommodated at least partially and which has an interior with at least two holding areas, which are arranged essentially opposite one another.

Thus, the intraoral scanner with its head area can be hung or placed easily and quickly in the holding device.

Additional preferred and advantageous embodiments of the invention are subjects of the subclaims.

### BRIEF DESCRIPTION OF THE DRAWINGS

Additional details and features of the invention as well as advantages thereof follow from the description below of preferred embodiments of the invention with reference to the embodiments that are depicted by way of example in the drawings. Here:

FIG. 1 shows an isometric view of a first embodiment of the holding device according to the invention with a scanner,

FIG. 2 shows a schematized side view of the embodiment of FIG. 1,

FIG. 3 shows a first isometric view of a second embodiment of the holding device,

FIG. 4 shows a second isometric view of the second embodiment,

FIG. 5 shows a view of the second embodiment with a scanner from above,

FIG. 6 shows a longitudinal section through the embodiment of FIG. 5,

FIG. 7 shows a first section through the embodiment of FIGS. 5 and 6,

FIG. 8 shows a second section through the embodiment of FIGS. 5 and 6,

FIG. 9 shows an isometric view of a third embodiment of the holding device,

FIG. 10 shows a view of the third embodiment from above, and

FIG. 11 shows a section through FIG. 10.

### DETAILED DESCRIPTION OF THE INVENTION

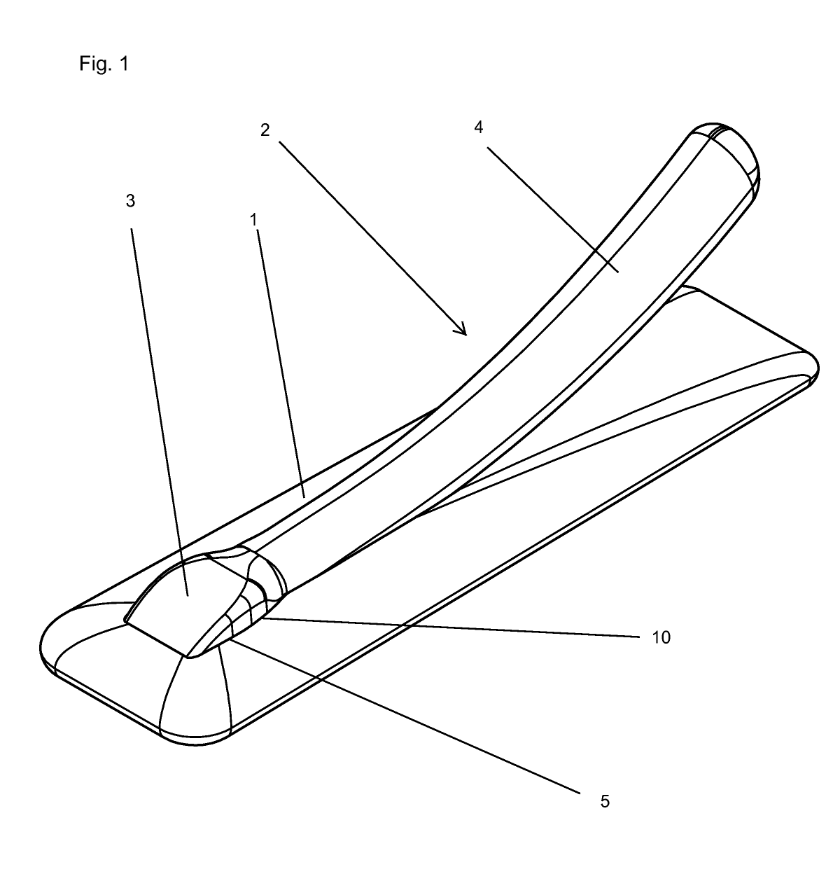

FIG. 1 shows an isometric view of a first embodiment of the holding device according to the invention with a scanner 2. A base element 1 of the holding device accommodates the scanner 2 in the area of the scanner head 3 and partially in the area of the scanner grip 4 in a receiving area 5.

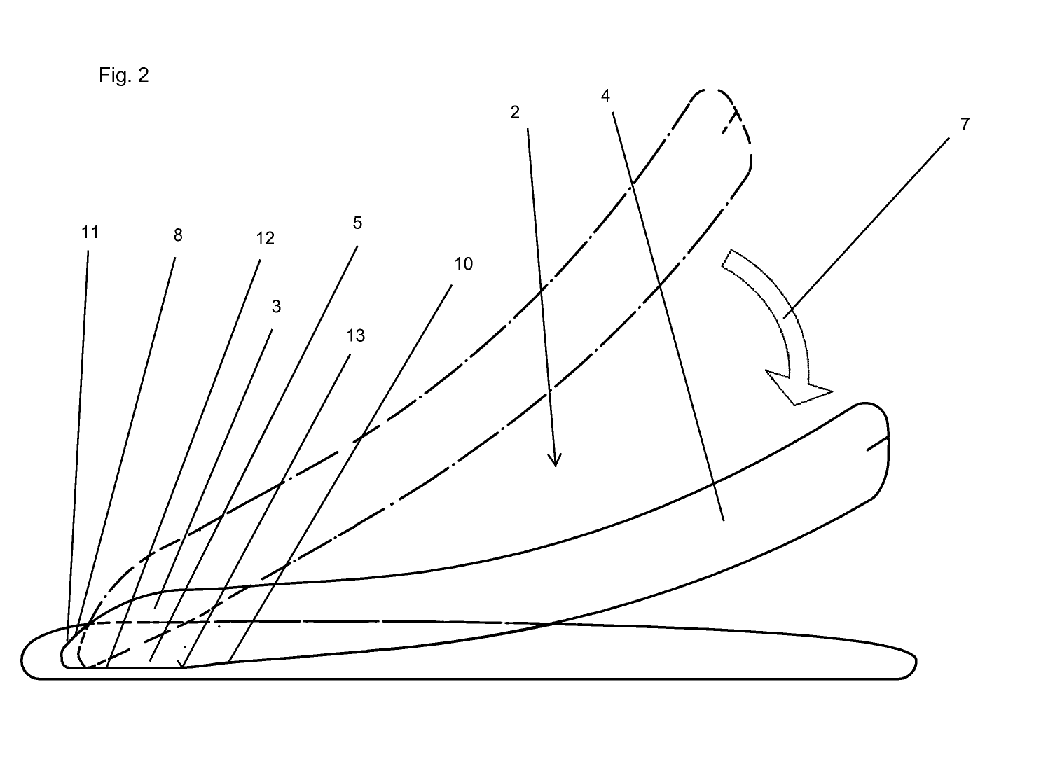

FIG. 2 shows a schematized longitudinal section, through the embodiment of FIG. 1. In this case, a scanner border 6 in dashed-dotted lines shows the beginning of a deposition movement being carried out in the direction of an arrow 7. This can be performed easily and intuitively. No complicated locking mechanisms, which would configure the handling less comfortably for the user, are necessary.

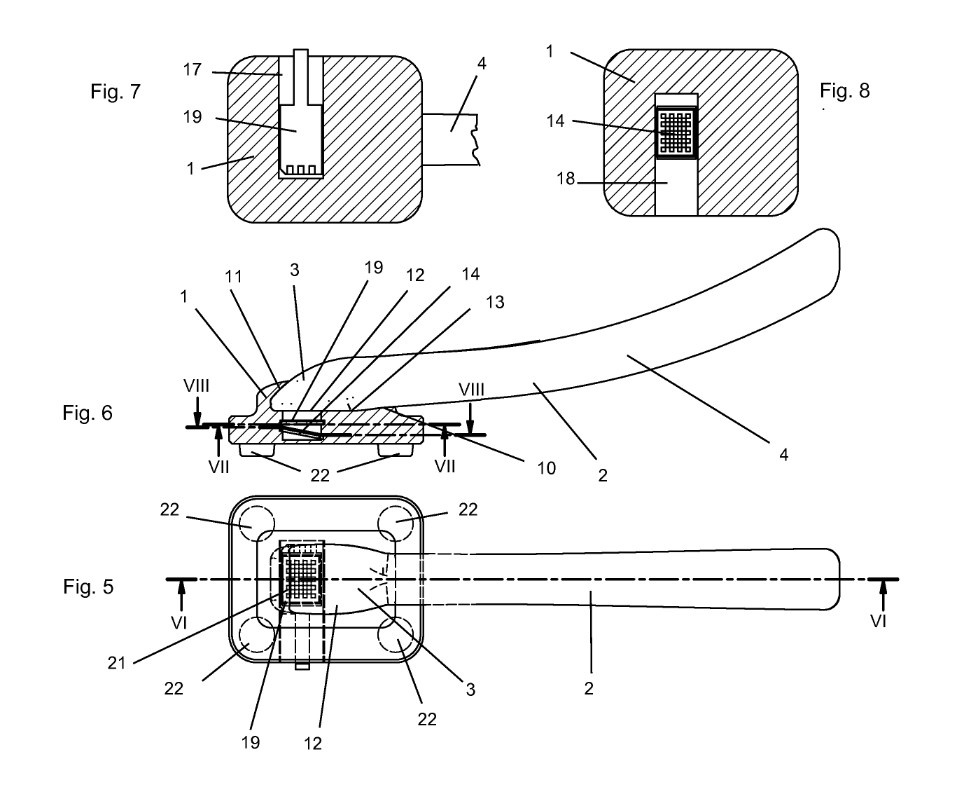

FIG. 2 further shows the contour of an interior 8 of the receiving area 5. The latter has two holding areas 10, 11 that are essentially opposite to one another. In this case, the rear holding area 10 receives the weight of the scanner 2 and stretches laterally upward, as FIG. 1 shows. In this case, the front holding area 11 counteracts a tilting movement. In addition, the scanner head 3 can preferably be lightly clamped. Thus, the weight of the scanner grip 4 can be better accommodated. To support the holding of the scanner 2 in the receiving area 5, the holding areas 10, 11 can have or can consist of a slip-proof material, for example silicone. A work area 12 of the scanner 2 with, for example, a scanner glass, comes to lie in this case on a base area 13 of the interior 8 of the receiving area 5 and is associated with the latter. This base surface 13 can have additional advantageous technical features that are different according to the invention. Thus, the scanner glass, which is usually located in the work area 13 of an intraoral scanner, can be preheated, for example, via a heated base area 13, which prevents a subsequent fogging of the screen when the scanner 2 is used. For this purpose, for example, a heating element 14 (FIGS. 5 to 8) can be provided.

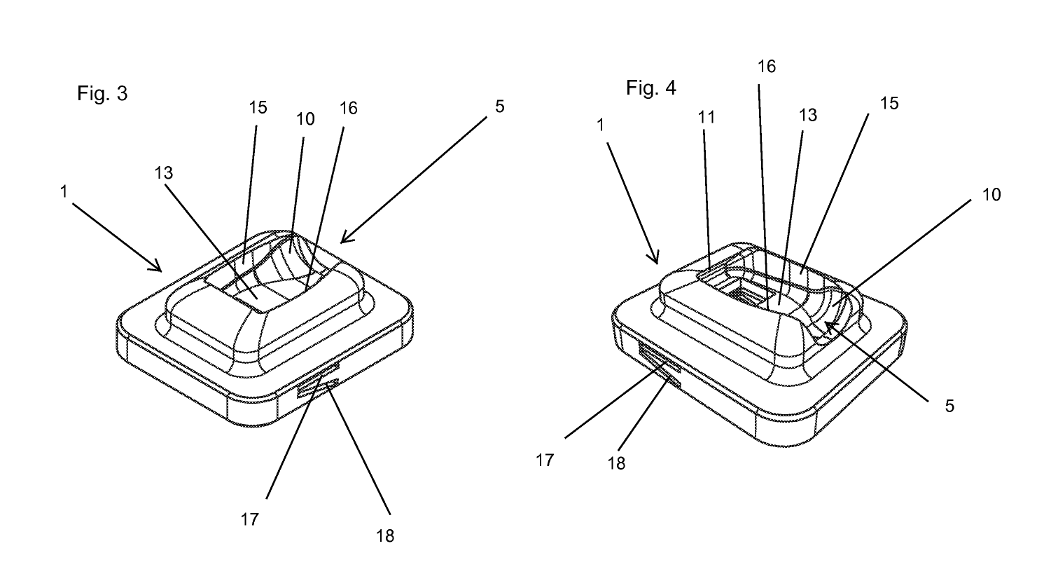

FIG. 3 and FIG. 4 show first and second isometric views of a second embodiment of a base element 1 of the holding device. In this case, the receiving area 5 is not accommodated recessed in the base element 1 as in the first embodiment, but rather it protrudes over the latter. The receiving area 5 essentially occupies only the scanner head 3 in this preferred embodiment. In addition to the holding areas 10, 11, boundary areas 15, 16, which are connected to the base area 13 in this embodiment, are detected. These boundary areas 15, 16 prevent a slipping of the scanner 2 to the side and result in the deposition movement. In this embodiment, the holding areas 10, 11 form with the boundary areas 15, 16 a border of the receiving area 5.

On one side of the base element 1, recesses 17, 18, which are open toward the side of the base element, are further detected. In these recesses 17, 18, for example, heating elements 14 or calibrating elements 19 (FIGS. 5 to 8) are accommodated. In this case, a calibrating element 19 has a calibrating pattern 21 (FIG. 5), which can be used for calibrations of the scanner. These can be, for example, flat-field corrections or else corrections of heat-produced distortions of the optics of the scanner. In this case, the known calibrating pattern 21 is accommodated while the scanner is being stored in the holding device. Distortions of the pattern are discernible in a computer and can be corrected by computation. Preferably, different calibrating elements 19 can be brought into the base element for this purpose, since for different calibrations, different calibrating patterns 21 can be advantageous. Advantageously, in this case, the holding device can completely darken the operating area or else the measuring area of the scanner in order to avoid disruptions during calibration.

According to an alternative or additional embodiment of the invention, the calibration can also be done without a pattern. In this case, the known distance between the scanner head and the calibrating element is measured, and the measured and real values are compared to one another. Corresponding to the deviation, corrections or calibrations can then be performed. In a further development of the invention, which can also be used in the case of calibrating elements with calibrating patterns, the calibrating element is tilted toward the work area by a known angle. Thus, several known intervals for calibrations are available, and the calibration can be done more exactly. In another further development, the angle or the position of the calibrating element to the work area or the base area can be adjusted, for example via a switch or a lever. This can optionally be combined with an adjustment system for the heating element; thus, for example, it can first be calibrated, and then the heating element can be pushed to the work area in order to heat the latter. The pattern can also be projected from the scanner itself onto the surface of the calibrating element. Then, the pattern does not have to be applied permanently to the calibrating element.

FIG. 5 shows a schematized view of the second embodiment of FIGS. 3 and 4 with a scanner 2 from above. The calibrating element 19 with the calibrating pattern 21 is detected below the work area 12 of the scanner head 3. Embodiments in which the heating element and the calibrating element are designed in one piece, for example by a heating element that is printed with a calibrating pattern, are also conceivable. Footings 22 are discernible below the base element 1. The latter can serve as supports for the base element 1 or else can be connected by friction or can be integral, for example via suction cups or else adhesive compounds, with a base, for example the treatment chair or a table surface.

FIG. 6 shows a longitudinal section through FIG. 5. The positions of the calibrating element 19 and the heating element 14 in the base element 1 are detected. In this case, the work area 12 associated with the base area 13 lies above the calibrating element 19. To this end, in this embodiment, a gap between the calibrating element 19 and the work area 12 is provided.

Embodiments in which the work area 12 and the calibrating pattern 21 are not separated from one another are also conceivable.

FIG. 7 shows a first section along the line VII-VII in FIG. 6. The calibrating element 19 is detected in the recess 17 in the base element 1. In a further development of the invention, the calibrating element 19 can also take on other tasks and, for example, it can produce a wireless data connection to the scanner and optionally read data that were detected in advance by the scanner. Of course, a means for data transfer, optionally also via a galvanic connection, can be arranged separately in the base element.

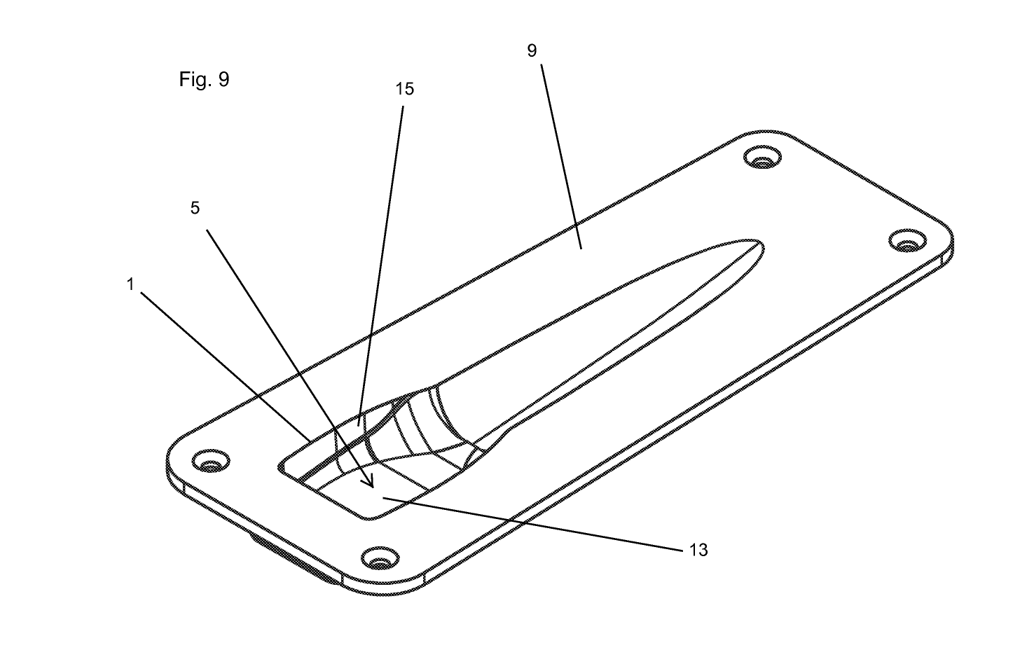

FIG. 8 shows a second section along the line VIII-VIII in FIG. 6. The heating element 14 is detected in the recess 18 in the base element 1.

FIG. 9 shows an isometric view of a third embodiment of the holding device. In the latter, the base element 1 is not, as described in the preceding embodiments of the invention, arranged on a surface, but rather recessed in a surface, for example of a table or a treatment chair, and it has a mounting plate 9. The receiving area 5 in this case is recessed in the surface.

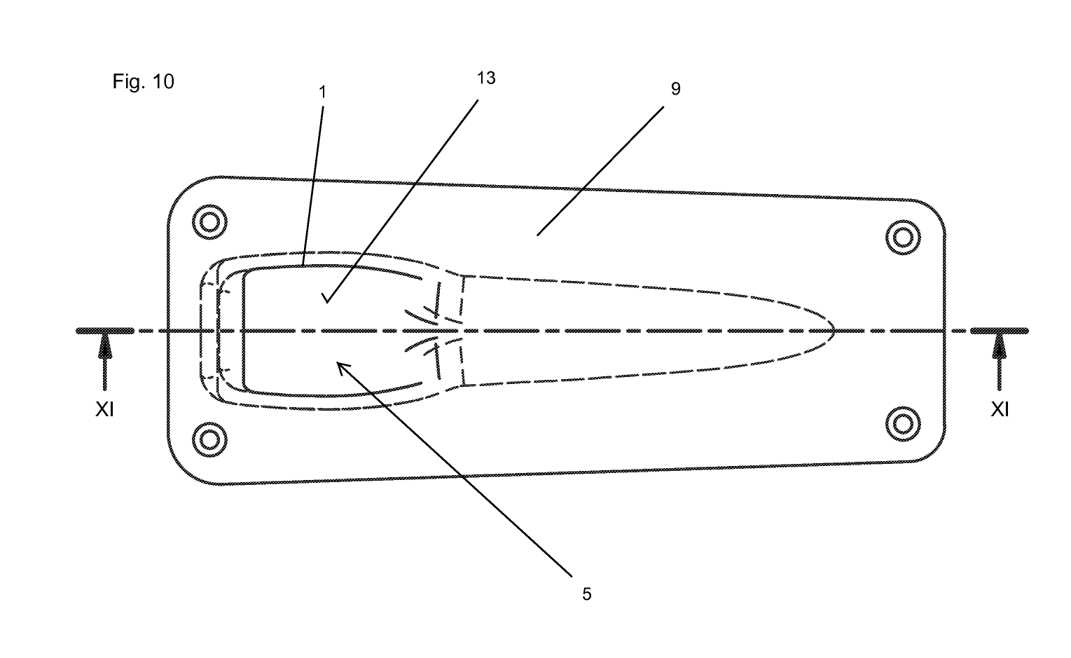

FIG. 10 shows a view of the third embodiment from the top. Heating or calibrating elements that are not depicted in this embodiment can also be installed in the base area 13. An exchange could then be carried out from the top before the scanner 2 is put into position.

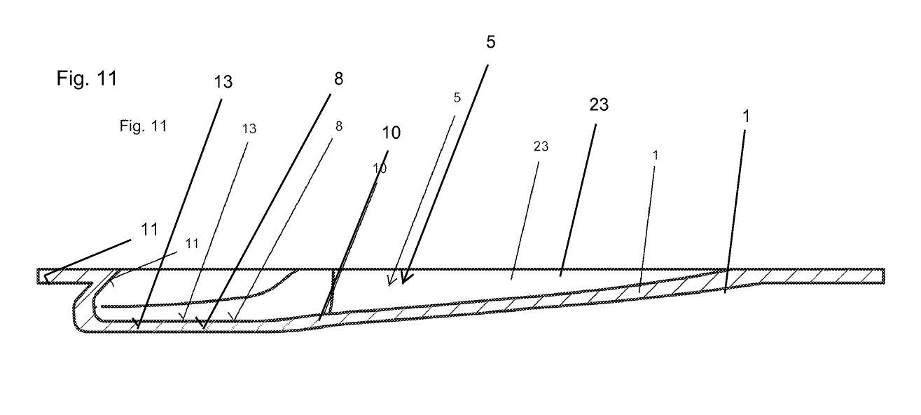

FIG. 11 shows a section along the line XI-XI in FIG. 10. It is seen how the holding area 11 opposite to the holding area 10 is arranged open to the base area 13 in essentially a V shape. The thus comprised part of the interior 8 occupies the front part of the scanner head 2. The especially long rear area 23 of the receiving area 5 in this embodiment can be used in a further development of the invention for additional functions of the holding device. Thus, for example, a charger, which is used inductively or via a galvanic connection to charge a battery in the scanner 2, can be arranged in the base element 1.

A wireless scanner could thus exchange data and calibrate itself, for example, during positioning in the holding device. In addition, the scanner head can be preheated for a subsequent treatment, and the scanner can be charged at the same time. In order to put one or more of these functions into operation, a switch can be provided on the base element. In a preferred further development of the invention, this switch is thrown when the scanner is inserted or removed. Heating, charging functions, etc., are thus powered only when a scanner is actually located in the holding device. This saves energy and forestalls possible damage, for example by the holding device or the heating element being overheated.

In a further development of the invention, in addition, a sensor for the temperature of the exterior of the scanner can also be provided. The latter can show its information, for example, via a display on the holding device or else convey said information to a computer that is connected to the scanner and/or the holding device. In a special application of the holding device, the temperature of the heating element can also be regulated based on the sensor information. This can be useful, for example, when the scanner is to be used in veterinary dentistry, since the temperature of the work area can be matched to the body temperature of the respective type of animal.

1. Holding device with a base element for a handpiece of an intraoral scanner, which has a head area (3), characterized by a receiving area (5) of the base element (1), in which the head area (3) can be snugly accommodated at least partially and which has an interior (8) with at least two holding areas (10, 11), which are arranged essentially opposite to one another.

2. Holding device according to claim 1, wherein the interior (8) has a base area (13), which is associated with a work area (12) of the head area (3).

3. Holding device according to claim 2, wherein at least one holding area (11) is a U-shaped or V-shaped holding device, which is open toward the receiving area (5).

4. Holding device according to claim 1, wherein the interior (8) has at least one, preferably two, boundary areas (15, 16) for the receiving area (5).

5. Holding device according to claim 4, wherein the boundary area (15, 16) adjoins the base area (13).

6. Holding device according to claim 4, wherein the boundary area (15, 16) at least partially contains holding areas (10, 11).

7. Holding device according to claim 1, wherein the base area (13) has a heatable electric or electronic heating element (14).

8. Holding device according to claim 1, wherein the base element (1) has an inductive charging device.

9. Holding device according to claim 1, wherein the base element (1) has galvanic contacts of a charging device.

10. Holding device according to claim 2, wherein the base area (13) has a calibrating pattern (21).

11. Holding device according to claim 10, wherein the heating element (14) has the calibrating pattern (21).

12. Holding device according to claim 10, wherein the heating element (14) and the calibrating pattern (21) are arranged beside one another.

13. Holding device according to claim 10, wherein the base element (1) has a recess (17, 18), in which a heating element (14) or a calibrating element (19) can be accommodated.

14. Holding device according to claim 13, wherein the calibrating element (19) has a calibrating pattern (12).

15. Holding device according to claim 13, wherein the position(s) of the heating element (14) and/or the calibrating element (19) is/are adjustable via a switch or lever.

16. Holding device according to claim 13, wherein the recess (17, 18) is open toward an outer side of the base element (1).

17. Holding device according to claim 7, wherein the base element (1) has at least one switch, with which the heating element (14) and/or the charging device can be activated.

18. Holding device according to claim 1, wherein the base element (1) has a support switch, whose switch position is controlled by the presence or absence of the scanner or scanner head.

19. Holding device according to claim 18, wherein the support switch switches the heating element (14) and/or the charging device on or off.

20. Holding device according to claim 1, wherein the base element (1) has a means for data transfer between the base element (1) and the handpiece.

21. Holding device according to claim 1, wherein the base element (1) completely covers a measuring area of the handpiece.

22. Holding device according to claim 1, wherein the holding device has a temperature sensor.

23. Holding device according to claim 22, wherein the holding device has a readout, in particular a display, for a value determined by a temperature sensor.
